(19) United States
(12) Patent Application Publication
(10) Pub. No.: US 2014/0287159 A1
(43) Pub. Date: Sep. 25, 2014

(54) CONDUCTIVE PASTE FORMULATIONS FOR IMPROVING ADHESION TO PLASTIC SUBSTRATES

(71) Applicant: Intrinsiq Materials, Inc., Rochester, NY (US)

(72) Inventors: Michael Carmody, Webster, NY (US); Janet Heyen, Rochester, NY (US)

(73) Assignee: Intrinsiq Materials, Inc., Rochester, NY (US)

(21) Appl. No.: 14/219,087

(22) Filed: Mar. 19, 2014

Related U.S. Application Data
(60) Provisional application No. 61/803,840, filed on Mar. 21, 2013.

(51) Int. Cl. C09D 5/24

(52) U.S. Cl. CPC C09D 5/24
USPC 427/555; 252/512

(57) ABSTRACT

A conductive paste for screen application to a substrate has a mixture of copper particles having a mean diameter between 1.0-5.0 micrometers and polymer-coated copper nanoparticles having a mean diameter from 10 nm to 100 nm. The ratio of the copper particles to the nanoparticles is between 2:1 and 5:1 by weight. The paste has a resin comprising a binder portion and a solvent portion, wherein the binder portion is about half of the resin by weight, and a plasticizer having a boiling point above about 200 degrees C., wherein the plasticizer is from 1-3% of the paste, by weight.

### CROSS-REFERENCE TO RELATED APPLICATIONS

This application claims the benefit of U.S. Provisional Patent Application Ser. No. 61/803,840, filed on 21 Mar. 2013, entitled “Conductive Paste Formulations for Improving Adhesion to Plastic Substrates” in the names of Michael J. Carmody et al., the contents of which are incorporated fully herein by reference.

### FIELD OF THE INVENTION

The invention relates generally to materials that are applied to a substrate and treated to form a conductive pattern thereon, and more particularly relates to a conductive copper paste formulation that uses a combination of metal flake and nanoparticle materials for forming conductive traces, with an added plasticizer component.

### BACKGROUND OF THE INVENTION

Fabrication of mass-produced electronic items typically involves temperature- and atmosphere-sensitive processing. Conventional material deposition systems for electronic fabrication, including plasma-enhanced chemical vapor deposition (PECVD) and other vacuum deposition processes, rely on high temperatures and rigidly controlled ambient conditions. Conventional processes are typically subtractive, applying a conductive or other coating over a surface, treating the coating to form a pattern, then removing unwanted material. The conventional method for forming copper traces is one example of this process, requiring multiple processing steps with the use of toxic chemicals and the complications and cost of proper waste disposal.

There is considerable interest in migrating to cheaper, lighter, more flexible substrates such as polyethylene teraphthalate (PET) and the use of additive printing processes that reduce waste and environmental damage.

Recent advances in printed electronics provide solutions that reduce the cost, complexity, and energy requirements of conventional deposition methods and expand the range of substrate materials that can be used. For printed electronics, materials can be deposited and cured at temperatures compatible with paper and plastic substrates and can be handled in air. In particular, advances with nanoparticle-based inks, such as silver, copper, and other metal nanoparticle-based inks, for example, make it feasible to print electronic circuit structures using standard additive printing systems such as inkjet and screen printing systems. Advantageously, nanoparticle-based inks have lower curing temperatures than those typically needed for bulk curing where larger particles of the same material are used.

A number of methods have been used for deposition of the conductive material in suitable patterns on different types of substrates. Among methods used are ink-jet printing, screen printing, and various other printing methods. Various formulations have been used for providing conductive inks and pastes that can be printed onto the substrate, using different arrangements of metal powders and other materials.

Nanoparticulate copper and other conductive metals have shown considerable promise as candidate materials for conductive inks and pastes. These materials are applied to the substrate in an additive manner, then cured by sintering, localized application of intense heat that tends to bond adjacent particles to each other to form conductive paths.

While some progress has been made in demonstrating suitable performance and commercial applicability of additive methods for forming conductive traces, results thus far have shown that there is room for improvement. Among aspects of improvement needed are the following:
(i) Adhesion. There must be good adhesion between the applied material and the substrate before and after sintering.
(ii) Response to sintering energy. Because of the high localized energy levels required for sintering, cracking and delamination have been persistent problems for curing the applied materials. The heat that is generated during sintering is resident in the trace for only very short intervals (less than one millisecond), allowing the use of inks and pastes on temperature-sensitive plastic substrates. However, the heat generated can decompose and vaporize polymers in the applied paste, including polymers used to coat the nanoparticles and polymers used as binder. Venting of the resulting vapor can cause bubbling and cracking in the surface of the sintered trace, detrimental to good adhesion. In addition, substrates with very low glass transition (Tg) temperatures, such as polyethylene terephthalate (PET), can slightly deform under localized heat conditions. This dimensional instability can, in turn, introduce stresses in the sintered copper traces and cause cracks and delamination from the substrate and poor conductivity.
(iii) Curing efficiency. Conventional methods of curing conductive pastes include oven-curing, with use of high-energy illumination sources, such as Xenon bulbs, that can be relatively inefficient, causing wasted heat energy. The generated heat energy is broadly distributed, rather than being focused on the deposited ink. Because of this, the substrate must also be heated to the temperatures needed to cure the trace. The needed levels of heat energy for this purpose can cause degradation of the substrate and effectively restricts the substrates that can be used, preventing the use of many types of plastics and other flexible and less costly substrates.
(iv) Substrate options. As noted earlier, PET is one type of less expensive substrate material that offers reduced waste and environmental impact. However, forming conductive traces on PET and other plastics remains challenging due to heat problems. Exemplary substrates include plastics, textiles, paper, sheet materials, and other materials that provide a suitable surface for depositing a pattern of nanoparticle-based ink.
(v) Performance. For industry acceptance and commercial viability, conductivity of the applied traces needs to be as low as 3× bulk or better. Conventionally formed copper traces have a resistivity of about 1.7 μΩcm; this provides a reference value against which relative conductivity of a material is compared. The “bulk ratio” is a multiple of this resistivity and is used as a practical measure of how well a conductive trace performs. In conventional practice as of the date of this application, printed traces formed from nanoparticle copper have been shown to achieve bulk ratios no better than about 6 (that is, no lower than 6 times 1.7 μΩcm). The desired levels of conductivity/resistivity can be difficult to achieve with current processes/ink formulations. There is also motivation to reduce the costs associated with formulation, printing, and conditioning of conductive inks.
(vi) Resolution. Higher resolution, using thinner conductive traces and allowing higher density of traces, is difficult to achieve with inefficient curing processes, due to factors such as surface distortion due to excess heat, for example.
   Factors (i) to (vi) given above are only some of the areas of improvement that are of interest to those who are developing and using printed conductive traces. Thus, it can be seen that improvement with respect to any of factors (i)-(vi) would help to make printing of conductive traces more commercially viable as an alternative to conventional photolithographic etching methods.

### SUMMARY OF THE INVENTION

The present invention is directed to overcoming one or more of the problems set forth above. Briefly summarized, according to one aspect of the present invention, there is provided a conductive paste for screen application to a substrate, the conductive paste comprising:
a) a mixture of copper particles having a mean diameter between 1.0-5.0 micrometers and polymer-coated copper nanoparticles having a mean diameter from 10 nm to 100 nm, wherein the ratio of the copper particles to the nanoparticles is between 2:1 and 5:1 by weight;
b) a resin comprising a binder portion and a solvent portion, wherein the binder portion is about half of the resin by weight; and
c) a plasticizer having a boiling point above about 200 degrees C., wherein the plasticizer is from 1-3% of the paste, by weight.

Advantageously, embodiments of the present invention provide an expanded sintering latitude for the conductive paste.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings.

FIG. 1 is a graph showing sintering latitude for conductive traces with the formulation of an embodiment of the present invention.

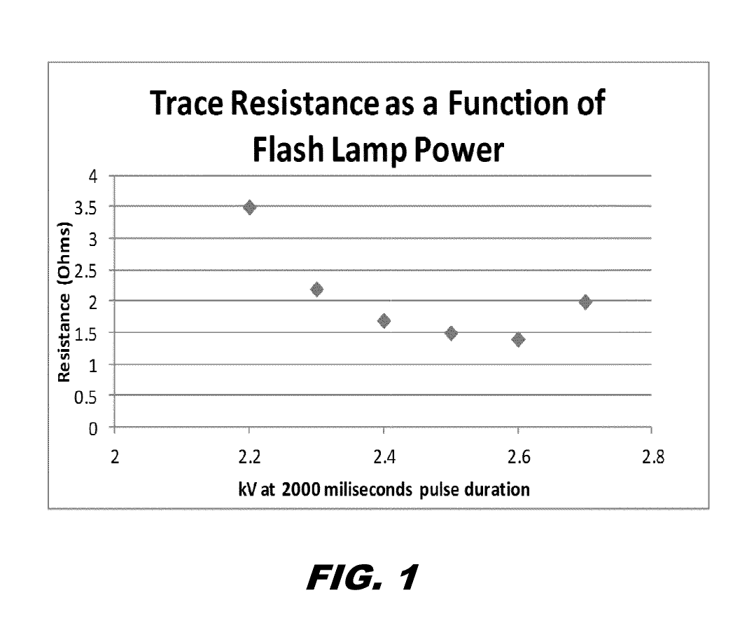

### DETAILED DESCRIPTION OF THE INVENTION

The following is a detailed description of the preferred embodiments of the invention. It is understood that the elements not shown specifically or described may take various forms well know to those skilled in the art.

Where they are used, the terms “first”, “second”, and so on, do not necessarily denote any ordinal or priority relation, but may be used for more clearly distinguishing one element or time interval from another.

In the context of the present disclosure, the terms “ink” and “paste” are used equivalently and are terms of art that broadly apply to materials that are deposited in a pattern on a substrate in a viscous, generally fluid or paste form and are sintered and otherwise cured after deposition and drying by applying a curing energy such as heat or light energy. Sintering is a curing process by which curing energy effects a structural change in the composition and/or arrangement of particles in the ink or paste. A conductive paste may or may not be conductive when formulated and may require application and sintering for conductivity.

Curing may also have additional aspects for ink or paste conditioning, such as sealing or removal of organic coatings or other materials that are provided in the ink formulation but not wanted in the final, printed product. In the context of the present invention, the term “curing” is used to include drying, sintering, and any post-sintering processing as well as other curing processes that employ the applied light energy for conditioning the deposited ink or paste.

The terms “nanoparticle-based material”, “nanoparticle-based ink”, “nanoparticle-based paste”, “nanoparticle material”, “nanoparticle ink” or “nanoparticulate material” refer to an ink or paste or other applied viscous fluid that has an appreciable amount of nanoparticulate content, such as more than about 5% by weight or volume.

In the context of the present invention, the term “substrate” refers to any of a range of materials upon which the nanoparticle ink or paste is deposited for curing. Exemplary substrates include plastics, textiles, paper, sheet materials, and other materials that provide a suitable surface for depositing a pattern of nanoparticle-based ink or paste. Substrates can be flexible or rigid.

In the context of the present invention, the term “copper flake” or, more generally “metal flake” refers to metal particles provided as a powder having a mean diameter from 1.0 to 8.0 micrometers.

As used herein, the term “energizable” relates to a device or set of components that perform an indicated function upon receiving power and, optionally, upon receiving an enabling signal.

Reference in the specification to “one embodiment” or to “an embodiment” means that a particular feature, structure, or characteristic described in connection with the embodiments is included in at least one embodiment of the invention. The appearances of the phrase “in one embodiment” or “an embodiment” in various places in the specification are not necessarily all referring to the same embodiment.

Embodiments of the present invention provide a formulation that has been shown to provide improved adhesion and performance of sintered traces for conductive pastes. In working with nanoparticle-based inks and pastes, the inventors have observed a number of improvements in materials application and performance due to characteristics of nanoparticle arrangement, but recognize that there are still areas requiring improvement with respect to various aspects of material and process performance. One aspect of the current process that can be improved relates to poor adhesion, delamination, and cracking of the applied trace materials. These materials tend to harden and delaminate, separating from the substrate surface in some cases. The inventors have found that mixture of the metal materials with suitable plasticizers and solvents can significantly help to reduce or eliminate adhesion problems. Further, the inventors have found that a particulate mixture that includes metal flake with a much smaller amount of nanoparticle materials can provide improvements in circuit trace preparation, particularly with respect to sintering response and performance.

An object of the present invention to improve the plasticity of sintered traces by using high boiling point (bp) temperature solvents that remain in the printed traces after photonic sintering. These solvents must be compatible with the solvents used in making the paste, and must plasticize the polymer that is used as binder and that is used to coat the copper particles. Typical plasticizers meeting these criteria are solvents like glycerol (bp 290° C.) and N-methylpyrrolidone (NMP, by 203° C.).

### Formulation

According to an embodiment of the present invention, the basic conductive paste formulation includes particulate copper and resin components, with an added plasticizer. For the copper component, embodiments of the present invention use a formulation with some amount or combination of copper nanoparticles coated with a polymer or copper/copper-oxide nanoparticles that have a copper core with a CuO shell. An amount of copper flake is also used, with particle sizes much larger than nanoparticle range, such as having a mean diameter from 1 to about 8 micrometers (um).

For resin and plasticizer components, additional dispersant, about 8% PVP (Polyvinylpyrrolidone) is also used, along with a solvent that has some amount of a sintering enhancer, such as from about 1-5 weight % of glycerol, optionally also with 1-5 weight % of ethylene glycol. Glycerol, with a vapor pressure of about 1 mm at 20 degrees C., appears to work well as a plasticizer.

Alternately, some other solvent having a high boiling point above about 200 degrees C. and a low vapor pressure below about 2 mm mercury at 20 degrees C. can be used, with a liquid or solid sintering enhancer in place of some or all of the glycerol content. Alternative sintering agents can include solid additives that may be non-volatile but are vaporized when sintering energy is applied. The plasticizer can be some portion of the solvent component in the resin or may be additional to the resin.

According to an embodiment of the present invention, the plasticizer is from 1-3% of the paste, by weight, and has a boiling point above about 200 degrees C. The plasticizer can be taken from the group consisting of glycerol; 1,2-dodecanediol; 1,2-decanediol; and N-methylpyrrolidone.

Among the numerous solvents that can be used in addition to or in place of glycerol are 1-methoxy-2-propanol, diethylene glycol, diethylene glycol monoethylether, diethylene glycol monobutyl ether, diethylene glycol monoethylether acetate, diethylene glycol monobutylether acetate, cyclohexanol, and 2-methyl-2,4-pentanediol.

Various glass frit materials may also be incorporated from 0.5 to 5 weight %. These are materials which are well known in printed electronics and may be obtained from vendors such as Asahi Glass, Ceradyne, or others. Useful frit materials have mean particles sizes which can range from 1 to 10 microns.

Polymer encapsulated copper nanoparticles are familiar to those skilled in nanoparticle applications and are described in commonly assigned U.S. Patent Application No. 2014/0009545 entitled “Conductive ink formulas for improved inkjet delivery” by Carmody, the contents of which are incorporated herein by reference in its entirety.

The binder or coating in the resin formulation helps to prevent agglomeration and to thereby maintain the high ratio of surface area to particle mass, which confers many of the advantageous properties of nanoparticles. Binders that can be used include, but are not limited to, polyvinyl acetate such as VINNAPAS B60™ polyvinyl acetate; polyvinyl butyral resin such as Butvar B79™ polyvinyl butyral resin; BYK 4509™ or other salt of a polymer with acidic groups, a polyacrylate-based surface additive such as BYK 354™ polyacrylate-based surface additive; Elvacite 2044™ n-butyl methacrylate polymer; an acrylic resin, such as Elvacite 2028™ acrylic resin; ethyl cellulose; or similar polymers. (Elvacite® is a registered trademark of Lucite International, Inc.; VINNAPAS is a registered trademark of Wacker Chemie AG; Butvar is a registered trademark of Eastman Chemical Co.; BYK is a registered trademark of Altana.)

The nanoparticles used in the paste formulation can be between 0.5-500 nm. Advantageously, therefore, the present invention can be implemented for a wide range of nanoparticle inks and pastes including those with larger particles which are often cheaper to produce, but do not otherwise work well for forming conductive traces.

For inventive formulations, the ratio of copper flake to nanoparticle copper is in the range from 2:1 to 5:1 by weight. One source of suitable copper flake is product CU 101 from Atlantic Equipment Engineers, Bergenfield, N.J. The mean diameter of the polymer-coated nanoparticles can vary between about 10 nm and 100 nm.

### EXAMPLE 1

### Comparative Paste A

Into a porcelain bowl was weighed 36.0 g of amorphous copper powder of mean diameter 1.0-5.0 micrometers (Cu CH UF 10 from Ecka Granules GmbH) and 9.0 g of polymer-coated nanoparticles of mean diameter 50 nm. To these powders was added 2.5 g of a resin having polymer (binder) and solvent components, the polymer component about half of the resin by weight. According to an embodiment of the present invention, the polymer is 1.25 g of 40,0000 molecular weight polyvinylpyrrolidone (PVP); the solvent is 1.0 g of ethylene glycol (EG), and 0.25 g of diacetone alcohol. The mixture was kneaded with a spatula until a thick paste was obtained. This paste was further mixed on a three roll mill until a uniform viscous paste was obtained.

### Inventive Pastes A, B, and C

Inventive pastes A, B, and C were prepared as Comparative A above except that the solvent portion has from 1, 2, or 3 weight percent of glycerol in place of some of the ethylene glycol.

The ratio of copper flake to nanoparticle copper is in the range from 2:1 to 5:1 by weight. The mean diameter of the polymer-coated nanoparticles can vary between about 10 nm and 100 nm.

### Photonic Sintering of Pastes

Traces measuring about 1 mm wide by 48 mm long were screen printed using these pastes onto a PET substrate (DuPont Melinex 505). The printed substrate was dried in a vacuum oven for an hour. Photonic sintering was performed using a Xenon Sinteron 2000 flash system. Using this system, a Xenon flash lamp intensity was varied for duplicate samples of the same trace structure, through a range beginning when resistance of a printed trace could first be measured with a hand-held ohmmeter, and ending when no further resistance could be measured due to cracking or delamination. This range is termed the Sintering Latitude and relates to the relative usability of the paste and its response over a range of possible sintering energy levels. A larger sintering latitude indicates a material with more favorable working properties for production conditions, including improved adhesion. Comparative values of Sintering Latitude are compiled in Table 1 for Comparative paste A and Inventive pastes A, B, and C. To record sintering latitude, plots are made of the measured trace resistance as a function of the voltage (or energy in Joules) supplied to the flash lamp.

TABLE 1
Sintering of screen pastes prepared with amorphous copper

| | Copper | % | Sintering |
|---|---|---|---|
| Paste | Type | Glycerol | Latitude (Joules) |
| Comparative A | Amorphous | 0 | 0 |
| Inventive A | Amorphous | 1 | 54 |
| Inventive B | Amorphous | 2 | 410 |
| Inventive C | Amorphous | 3 | 270 |

From Table 1 it can be seen that no usefully conductive traces were obtained from Comparative Paste A, while Inventive Pastes that contain the glycerol plasticizer show significantly improved sintering performance. In addition to more favorable sintering latitude, adhesion of the Inventive A paste formulation was improved over that for the Comparative A paste, following curing.

### EXAMPLE 2

### Preparation of Comparative Pastes B and C

Comparative Paste B was prepared in the same manner as Comparative A above, except that a flaked copper powder whose mean diameter was between 4-13 micrometers was used. Comparative Paste C was similarly prepared, except that the amount of PVP binder was reduced from 1.25 g (normal binder level) to 1.00 g (low binder level).

### Preparation of Inventive Pastes D and E

Inventive pastes D and E were prepared as Comparative Pastes A and B above, respectively, except that glycerol was used in lieu of some of the solvent mixture in the resin, resulting in pastes containing 2% glycerol by weight.

The four pastes, Comparative B and C and Inventive D and E were printed onto PET and sintered as above, giving the data summarized in Table 2.

TABLE 2
Sintering of pastes made from copper flake

| | Copper | % | Binder | Sintering Latitude |
|---|---|---|---|---|
| Paste | Type | Glycerol | Level | (Joules) |
| Comparative B | Flake | 0 | Normal | 54 |
| Comparative C | Flake | 0 | Low | 111 |
| Inventive D | Flake | 2 | Normal | 317 |
| Inventive E | Flake | 2 | Low | 270 |

It can be seen from Table 2 that the Comparative pastes give some useful sintering latitude. However, incorporation of some quantity of glycerol plasticizer, such as from 1 to 3 weight percent, more than doubles the useful sintering range, with sintering latitude in excess of 260 joules, for example.

Thus, the inventors have found that incorporation of plasticizing high boiling solvents in copper screen pastes can result in significant improvement in sintering on low glass-transition temperature (Tg) substrates. This effect was seen using different kinds of micro-sized copper and different levels of binder in the pastes.

Thus, it can be seen that embodiments of the present invention provide a conductive paste for screen application, the conductive paste comprising a 2:1 to 5:1 mixture of amorphous copper powder of mean diameter 1-5 um to polymer-coated nanoparticles of mean diameter 50 nm; and a resin comprising about half of a polymer such as PVP, and wherein the other half of the resin includes from about 1-3 weight percentage of glycerol or other solvent having a boiling point above about 200 degrees C.

### EXAMPLE 3

### Preparation of Inventive Pastes F and G

Inventive pastes F and G were prepared in the same manner as Comparative B above, except that 1,2-dodecanediol (Paste F) and 1,2-decanediol (Paste G) were added to the solvent mixture, such that the diol plasticizers constituted about 1% of the total weight of the paste. These inventive pastes were screen printed onto PET and sintered as above, giving the data shown in Table 3.

TABLE 3
Sintering of pastes made from copper flake and diol plasticizers

| | | | | Sintering |
|---|---|---|---|---|
| | Copper | | Binder | Latitude |
| Paste | Type | % Plasticizer | Level | (Joules) |
| Comparative B | Flake | 0 | Normal | 54 |
| Inventive F | Flake | 1 % 1,2-dodecanediol | Normal | 710 |
| Inventive G | Flake | 1 % 1,2-decanediol | Normal | 883 |

It can be seen from Table 3 results that these two diol materials yield significant improvements in sintering latitude when compared to the Comparative paste B formulation. These two diol materials are actually low melting solids, with melting temperatures at or below 60° C. and not liquids like glycerol. The 1,2-dodecanediol melts at 56-60° C. and the 1,2-decanediol melts at 48-50° C.

While the experimental data shows successful results for formulations that use copper nanoparticles and copper metal flake, this process can be extended to other metals and elements for forming conductive and semiconductive patterns. For example, ink formulation, deposition, and sintering can employ other conductive and semiconductor materials such as Ag, Au, Pd, Pt, Ni, Si, alumina and their combinations thereof. For each of these materials, solvent mixture, ink or paste deposition, and sintering processes would follow similar steps, with corresponding changes according to the conductive or semiconductor materials used.

The printed electronic structures that can be formed by the present method are made of a metal or semi-metal, such as semiconductor material. Suitable metals for printing and curing in a pattern include, but are not limited to, copper, gold, silver, nickel, and other metals and alloys. Semi-metal materials including silicon can also be used. Furthermore, silicon particles that have been doped to provide semiconducting behavior (for example, doped with phosphorous or arsenic) are also suitable. Therefore, the present method can be used in production of both electronic structures, such as connecting traces between devices, and semiconducting devices themselves.

Sintering can be performed using Xenon flash illumination or using other radiant energy sources, such as laser light sources. Methods for sintering using patterned laser illumination are described, for example, in commonly assigned U.S. Patent Application Publication No. 2013/0337191 entitled “Method for depositing and curing nanoparticle-based ink using spatial light modulator” by Ramanujan et al., incorporated herein by reference in its entirety.

The use of laser radiation allows for the selection of a light wavelength that is well suited for the sintering of the nanoparticles while eliminating or minimizing damage to the coating. By using lasers as radiant energy sources, monochromatic light can be applied to the conductive paste at wavelengths most favorable to sintering and other curing functions, without contributions from other wavelengths, such as lower wavelength light that can be heavily absorbed in the upper layers of deposited material. Absorption of wavelengths in upper layers of the material nearest the surface can cause these upper layers to be inadvertently sealed, trapping binder and other materials that must be removed from beneath the surface. Advantageously, laser radiation provides sufficient energy for the removal of component materials in the precursor nanomaterial. This includes materials useful for improving ink application but not wanted in the final product, such as organic binders and particle coatings. With laser light, the spectral content and intensity can be specified and controlled so that the laser delivers the proper radiant energy to the applied material, at the proper depth. In this way, problems such as unwanted sealing of top layers can be avoided.

### Substrate Considerations

Tg and other thermal characteristics of the substrate can complicate the task of sintering in a number of ways when conventional Xenon flash energy is used. Substrates having relatively high thermal conductivity, such as aluminum, silicon, and ceramic substrates, for example, can conduct the needed heat away from the area of incident light before sintering energy levels are reached. Polymer-based substrates, such as ITO coated plastic substrates, can be damaged due to the higher thermal conductivity of the ITO coating. Alternate embodiments of the present invention can help to address problems related to thermal response by using laser light that can be focused onto a small area.

It is found that the present method is particularly suitable for a number of substrates including PET (polyethylene terephthalate), PI (Polyimide), PE (polyethylene), PP (Polypropylene), PVA (poly-vinyl alcohol), SiN (silicon nitride), ITO (indium tin oxide) and glass. On such substrates, the present application provides an improved method for producing high resolution lines compared to other systems. Particularly when used with laser illumination, the direct transformation (curing, sintering or otherwise) of the material by the laser energy allows for higher resolution features, reduces or avoids the need for adding further layers such as photoresist layers, and requires fewer stages to produce than do conventional methods. Printing and curing of electronic materials and components can be performed at low volumes as well as for large-scale, high volume production. In general, substrates need to be sufficiently clean in order to fully accept and cure the printed ink materials. Failure to clean the substrate prior to printing can lead to poor adhesion, degraded electrical performance, material contamination, and breakage. Cleaning of the substrate can be performed using suitable solvents, or alternately with surface treatments such as using corona discharge energy or treating with compressed gases or other methods.

Embodiments of the present invention advantageously allow high resolution features to be produced in a single stage process. In particular, the invention avoids the need for an extra layer, such as a photoresist layer, and its subsequent processing. Furthermore, unlike photoresist methods, the method of the present invention does not require the use of etchants to remove the unprotected, uncured structure. This is advantageous as it simplifies the production process and greatly reduces costs related to waste handling.

The invention has been described in detail with particular reference to certain preferred embodiments thereof, but it will be understood that variations and modifications can be effected within the scope of the invention.

What is claimed is:

1. A conductive paste for screen application to a substrate, the conductive paste comprising:
a) a mixture of copper particles having a mean diameter between 1.0-5.0 micrometers and polymer-coated copper nanoparticles having a mean diameter from 10 nm to 100 nm, wherein the ratio of the copper particles to the nanoparticles is between 2:1 and 5:1 by weight;
b) a resin comprising a binder portion and a solvent portion, wherein the binder portion is about half of the resin by weight; and
c) a plasticizer having a boiling point above about 200 degrees C., wherein the plasticizer is from 1-3% of the paste, by weight.

2. The conductive paste of claim 1 wherein the binder portion is a polymer taken from the group consisting of: polyvinylpyrrolidone, polyvinyl acetate; polyvinyl butyral resin, a salt of a polymer with acidic groups, a polyacrylate-based surface additive, an n-butyl methacrylate polymer; an acrylic resin, and ethyl cellulose.

3. The conductive paste of claim 1 wherein the solvent portion further comprises or more solvents taken from the group consisting of: ethylene glycol, diacetone alcohol, 1-methoxy-2-propanol, diethylene glycol, diethylene glycol monoethylether, diethylene glycol monobutyl ether, diethylene glycol monoethylether acetate, diethylene glycol monobutylether acetate, cyclohexanol, and 2-methyl-2,4-pentanediol.

4. The conductive paste of claim 1 wherein the copper nanoparticles comprise both copper-oxide nanoparticles that have a copper core with a CuO shell and copper nanoparticles that have a polymer coating.

5. The conductive paste of claim 1 wherein the plasticizer comprises one or more solids with melting temperature at or below 60° C.

6. The conductive paste of claim 1 wherein the plasticizer is taken from the group consisting of glycerol; 1,2-dodecanediol; 1,2-decanediol; and N-methylpyrrolidone.

7. A method for forming a pattern of conductive traces on a substrate, the method comprising:
a) forming a conductive paste for screen application, the conductive paste comprising a mixture of copper particles having a mean diameter between 1.0-5.0 micrometers and polymer-coated copper nanoparticles having a mean diameter from 10 nm to 100 nm, wherein the ratio of the copper particles to the nanoparticles is between 2:1 and 5:1 by weight; a resin comprising a binder portion and a solvent portion, wherein the binder portion is about half of the resin by weight; and a plasticizer having a boiling point above about 200 degrees C., wherein the plasticizer is from 1-3% of the paste, by weight;
b) applying the pattern of conductive paste to the substrate; and
c) curing the pattern of conductive paste using a radiant energy source.

8. The method of claim 7 wherein the radiant energy source is a laser.

9. The method of claim 7 wherein the radiant energy source is a xenon lamp.

10. The method of claim 7 wherein applying the pattern of conductive paste comprises using screen printing.

11. The method of claim 7 wherein the substrate is taken from the group consisting of polyethylene terephthalate, polyimide, polyethylene, polypropylene, poly-vinyl alcohol, silicon nitride, indium tin oxide, and glass.

12. The method of claim 7 wherein the applied pattern of conductive paste has a sintering latitude in excess of 260 joules.

13. A conductive paste for screen application to a substrate, the conductive paste comprising:
a) a mixture of copper particles having a mean diameter between 1.0-5.0 micrometers and polymer-coated copper nanoparticles having a mean diameter from 10 nm to 100 nm, wherein the ratio of the copper particles to the nanoparticles is between 2:1 and 5:1 by weight;
b) a resin comprising a binder portion and a solvent portion, wherein the binder portion is about half of the resin by weight; and
c) from 1-3% of the paste, by weight, of glycerol.

14. The conductive paste of claim 13 further comprising from 1-5 weight % of ethylene glycol.

15. The conductive paste of claim 13 further comprising from 0.5 to 5% by weight of glass frit.
